(19) United States
(12) Patent Application Publication
(10) Pub. No.: US 2001/0037373 A1
(43) Pub. Date: Nov. 1, 2001

(54) Systems and methods for simulating a web page

(75) Inventor: Vivien J. Cambridge, Slidell, LA (US)

Correspondence Address: FISH & NEAVE, 1251 AVENUE OF THE AMERICAS, 50TH FLOOR, NEW YORK, NY, 10020-1105, US

(73) Assignee: Triscan, Inc.

(21) Appl. No.: 09/812,761

(22) Filed: Mar. 20, 2001

Related U.S. Application Data
(60) Provisional application No. 60/190,616, filed on Mar. 20, 2000.

(51) Int. Cl. G06F 15/16; G06F 17/60

(52) U.S. Cl. 709/217; 709/203; 705/27

(57) ABSTRACT

Systems and methods for simulating on-line web pages are provided. An information provider who operates a web site may provide a local mass-storage medium such as a CD-ROM disk or DVD disk to prospective users of the web site. The disk may work in conjunction with the user's network connectivity software and the web site to quickly display high quality images and web pages. The system of the present invention provides communication between the user's computer and the web site so that the data and images presented to the user may be updated through the on-line connection. Since the images may reside on the customer's computer, the display of images is much faster than if the images were transferred across a communications network. Three-dimensional images, videos, movies, or audio-visual presentations may be viewed by the user. Simulation of high-speed broadband network connectivity may assist in marketing high-speed network services.

### CROSS REFERENCE TO RELATED APPLICATION

This application claims the benefit of U.S. provisional application Serial No. 60/190,616 filed Mar. 20, 2000, which is hereby incorporated by reference herein in its entirety.

### BACKGROUND OF THE INVENTION

This invention relates to systems and methods for the display of information. More particularly, this invention relates to systems and methods for simulating a presentation of a web page.

Currently, the majority of on-line subscribers utilize typically slow network connectivity technology. Data transfer rates for these network users are typically between 24 thousand and 56 thousand bits per second (bps). In order to transfer a compressed, high-resolution two-dimensional image that covers half of a typical computer screen, a standard 56k modem would require approximately 5 seconds to transfer the image. If a typical 33k modem were used, a similar image transfer would take approximately 15 seconds. Similarly, a single web page display sent over the Internet with only two graphical images may require more than 20 seconds to transfer using a typical 56k modem. If the images were in an uncompressed format and transferred using a typical 56k modem, download time may be in excess of seven minutes.

Wait times of several seconds for screen updates are often unacceptable to many Internet users. Interest in information is frequently lost if the web page updates are perceived as sluggish. The limitation on image transfer capacity has forced some information providers to limit the extent of graphics on their web sites. For example, the pictures presented to users are frequently small and the resolution is often poor.

As networks grow, information providers must find new and better methods of attracting the increasing number of users. Providers seeking market share must win and hold the attention of information consumers. The quality of a web site and the speed of its functionality greatly determine success in the marketplace. However, more complex and graphically detailed web sites slow down the functionality of the site, thus frustrating users. Increasing data transfer to facilitate information presentation would provide a significant advantage within an expanding marketplace. Furthermore, fast network connectivity could be more effectively marketed by demonstrating its functionality and benefits to consumers.

It is desirable to provide new systems and methods of information presentation to simulate rapid data transfer.

### SUMMARY OF THE INVENTION

The present invention relates to systems and methods for simulating a presentation of a web page. An information provider who operates a web site provides a local mass-storage medium such as a CD-ROM disk or DVD disk to prospective users of a web site. The disk works in conjunction with the user's network connectivity software and with the information provider's web site to quickly display high quality images and web pages. Since the images reside on the customer's computer, the display of images is much faster than if the images were transferred across a communications network.

In one aspect of the invention, a specific browser may be used to view images and information on the mass storage device and the information provider's web page, or a general web browser may be used.

In another aspect of the invention, users may be reminded of the information provider's web site with a banner on their screens that contains the information provider's web site address. Selecting the banner may execute the user's network connectivity software and display the information provider's web page. The banner may continue to be displayed even if the user visits other web pages.

In a further aspect of the invention, banners for web sites for fast network connectivity providers and banners for retailers may be alternated on a user's screen. Selecting the banner may execute the customer's network provider software and display the information provider's, or fast network service provider's, web page. The banners may continue to be displayed even when the customer visits other web sites.

In another aspect of the invention, the user's network service provider software may be executed in order to communicate with the information provider's server when the user requests new catalog items, lists of on-sale items, pricing information, shipping information, availability information, product option information, or the user wants to complete a purchase transaction.

In an additional aspect of the invention, the mass storage medium distributed to potential users may be any optical, magnetic, or magneto-optical storage device such as a CD-ROM or DVD.

In another aspect of the invention, the mass storage medium distributed to potential users may contain high resolution images, movie files, three-dimensional images, and audio-visual presentations. These images may be displayed and manipulated in real time.

In a further aspect of the invention, the mass storage media may be mass-mailed, distributed directly to customers of a retailer's store by mail or at the time of sale, or otherwise included in a package to be shipped to a customer who ordered items from a retailer's web site.

In another aspect of the invention, the distribution of the mass storage medium to the user may be accompanied by a discount coupon or gift coupon.

In an additional aspect of the invention, the browser software that operates on the local computer interacts with software on the web site's server to update information displayed to the user so that up-to-date data and images may be accessed on the storage medium while other data and images may be accessed on-line through the network connection.

In a further aspect of the invention, images and data from both the mass storage medium and a remote server may be retrieved to form a simulated on-line web page and thereby simulate high speed Internet access. In this way, high speed access can be marketed.

### BRIEF DESCRIPTION OF THE DRAWINGS

Further features of the invention, its nature and various advantages will be more apparent from the following detailed description of the preferred embodiments, taken in conjunction with the accompanying drawings, in which like reference characters refer to like parts throughout, and in which:

FIG. 1 illustrates a block diagram of a hybrid local/on-line rapid data transfer system in accordance with certain embodiments of the present invention;

FIG. 2 illustrates a flow diagram of a process for displaying a simulated on-line web page in accordance with certain embodiments of the present invention;

FIG. 3 illustrates a flow diagram of a process for a hybrid local/on-line rapid data transfer system in accordance with certain embodiments of the present invention;

FIG. 4 illustrates a flow diagram of a process for searching for items on the mass storage device that are offered for sale by the retailer in accordance with certain embodiments of the present invention;

FIG. 5 illustrates a flow diagram of a process of selecting an item from either a local catalog on a mass-storage medium or an on-line retailer catalog in accordance with certain embodiments of the present invention;

FIG. 6 illustrates a flow diagram of a process for selecting an item for purchase in accordance with certain embodiments of the present invention;

FIG. 7 illustrates a flow diagram of a process for selecting a three-dimensional image, video, movie, or audio-visual presentation for viewing in accordance with certain embodiments of the present invention;

FIG. 8 illustrates a flow diagram of a process for determining whether new items have been added to a retailer's available products in accordance with certain embodiments of the present invention; and

FIG. 9 illustrates a flow diagram of a process for determining which items offered by a retailer have special on-sale pricing in accordance with certain embodiments of the present invention.

FIG. 10 is an illustration of a screen display in accordance with certain embodiments of the present invention.

### DETAILED DESCRIPTION OF THE INVENTION

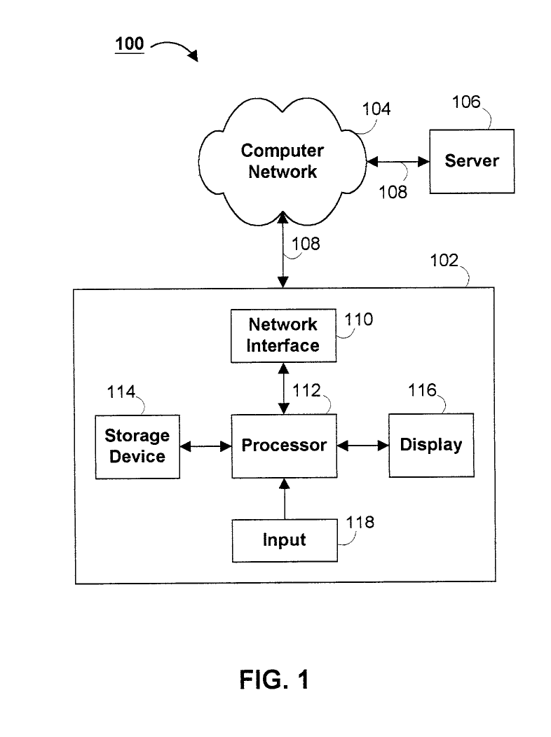

The present invention is now described in more detail in conjunction with FIGS. 1-10.

FIG. 1 illustrates a block diagram of a hybrid local/on-line rapid data transfer system 100 in accordance with one aspect of the present invention. As shown, system 100 may include a computing device 102, a computer network 104, a server 106 and communications links 108.

Computing device 102 may include network interface 110, processor 112, storage device 114, display 116, and input 118. Computing device 102 may be a personal computer, laptop computer, handheld computer, telephone, cellular phone, or any other suitable device.

Network interface 110 may be a modem, Ethernet card, cable modem, DSL modem, network card, USB interface, serial interface, parallel interface, infrared interface, radio frequency interface, microwave frequency interface, optical interface, electro-magnetic interface, or any other suitable interface.

Processor 112 may be a microprocessor, ASIC device, Field Programmable Gate Array (FPGA), Programmable Logic Device (PLD), integrated circuit, or any other suitable device.

Storage device 114 may be a hard drive, CD-ROM drive, CD-R drive, CD-RW drive, DVD drive, floppy drive, flash RAM card or any other optical, electrical, electro-optical, magnetic, electromagnetic, magneto-optical storage device.

Display 116 may be any CRT, LCD, LED, organic LED, plasma display system, or any other optical, electro-optic, chemical, electro-chemical, magnetic, electro-magnetic display system.

Input 118 may be any keyboard, mouse, track ball, wheel, stylus, light pen, microphone, button, lever or any other optical, electrical, electro-optical, mechanical, or electro-mechanical device.

Computing device 102 may be connected to computer network 104 by communication link 108. Server 106 may be connected to computer network 104 by communications link 108.

Computer network 104 may be any Internet, Intranet, Local Area Network (LAN), Metropolitan Area Network (MAN), Wide Area Network (WAN), Virtual Private Network (VPN), wireless network or any other suitable computer network.

Server 106 may be any remote computer or computing device.

Communications link 108 may be copper wire, twisted pair, telephone line, coaxial cable, fiber-optic cable, satellite, radio transmission, microwave transmission, light wave transmission, electromagnetic transmission, a cable modem connection, a digital subscriber line (DSL), a dial-up connection, or any other suitable connection.

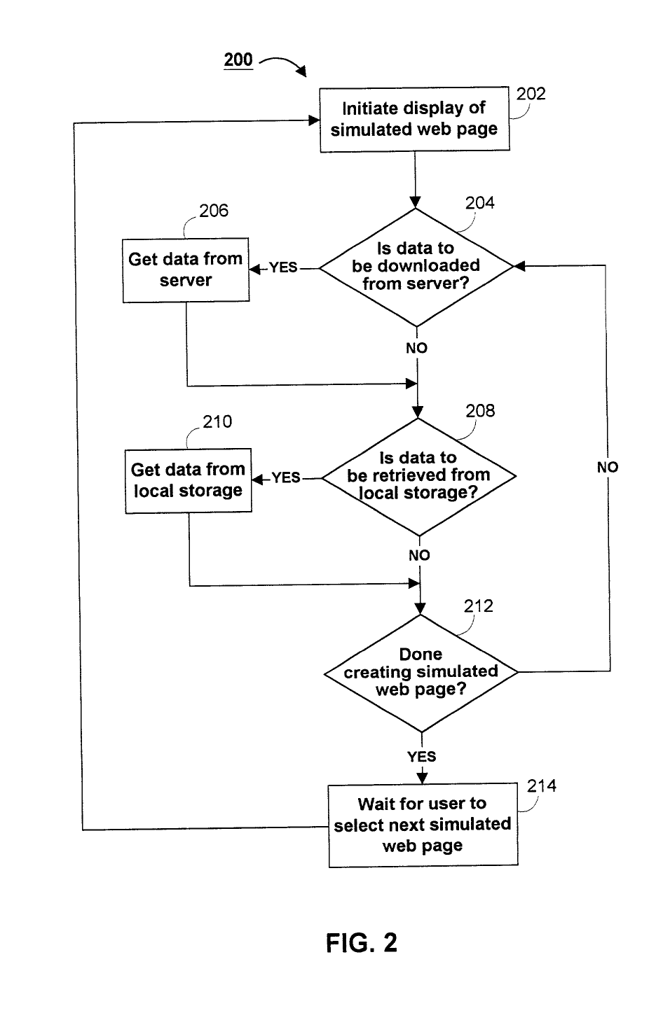

FIG. 2 illustrates a flow diagram of a process 200 for displaying a simulated on-line web page in accordance with one aspect of the invention. As shown, once process 200 has begun at step 202, the display of a simulated on-line web page is initiated. A determination may be made by server 106, computing device 102, or by computer network 104 as to whether data is to be downloaded from the server. Retrieving data from the server at step 206 may occur if the server is not busy, data traffic of computer network 104 is low, or the amount of data to be transmitted is low enough such that the process of displaying the simulated on-line web page on computing device 102 does not take so long as to frustrate the user. The data necessary to display the simulated on-line web page may or may not reside locally on computing device 102 and may or may not be current. If data is not to be downloaded from the server, step 208 determines whether data is to be retrieved from local storage. Step 208 may also invoked if it was determined that it is necessary to retrieve data from the server.

Determining if data is to be retrieved from local storage at step 208 may be determined in several ways. Server 106 may be too busy to process requests for downloading data. Traffic in computer network 104 may be such that the process of creating a simulated web page may take too long and frustrate the user. Data that was requested to be downloaded from the server may be graphical or audio-visual in nature where the process of displaying a simulated web page may take too long and frustrate the user. The data to display the simulated web page may not be available on the server, and it may be necessary to retrieve it from local storage. Data necessary to create the simulated web page may already reside on computing device 102.

If it is determined at step 208 that data may be retrieved from local storage, step 210 may retrieve the data from local storage. If it is determined at step 208 that data may not be retrieved at step 208, step 212 may then determine if the simulated web page has been completely created. Also, if data is retrieved from local storage at step 210, a determination of whether the simulated web page has been completely created may take place at step 212.

At step 212, a determination may be made as to whether creation of the simulated web page is done. This may be determined if all of the data necessary to create the page is available either locally on computing device 102 or on server 106, the data has been transferred to computing device 106, and a simulated web page has been rendered on computing device 102. If the simulated web page has been completely created, step 214 may wait for the user to select the next simulated web page. If the creation of the simulated web page has not been completed, the process of displaying a simulated web page may return to step 204 to determine if data is to be downloaded from the server.

At step 214, the process may wait for a user to select the next simulated web page. In the event that a user makes this selection, the process may then return to step 202, where the display of the simulated web page may be initiated.

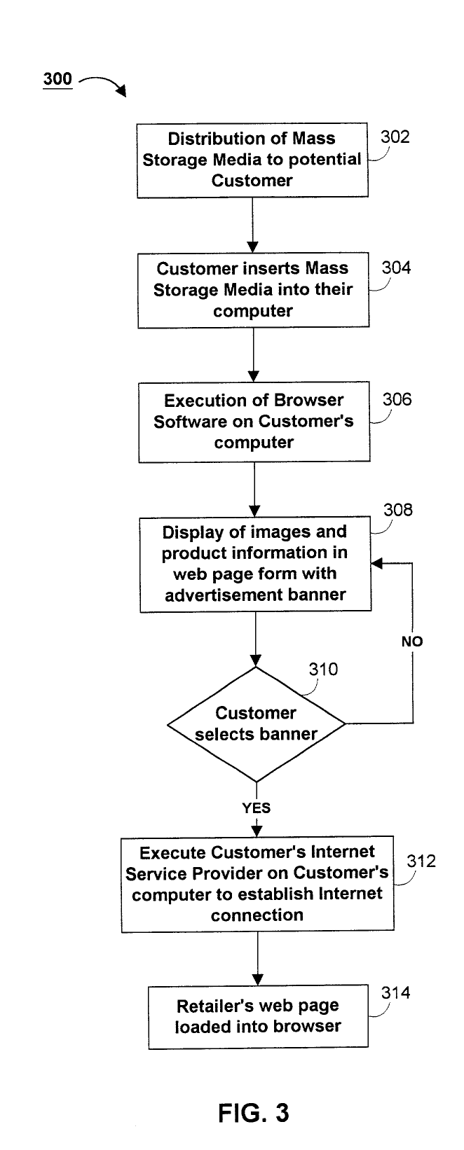

FIG. 3 illustrates a flow diagram of a process 300 in accordance with one aspect of the present invention. As shown, once process 300 has begun at step 302, a retailer or its agents may distribute a mass storage media to a potential customer.

The mass storage media may be any optical, magnetic, or magneto-optical storage device capable storing digital information. The mass storage media may be a CD-ROM disk or a DVD disk, or any other suitable mass storage media to hold activation software and utility data of a retailer or information provider, as well as survive distribution with little or no data corruption or loss.

Distribution of the mass storage media may be accomplished by a number of different methods. For orders placed with the retailer's web site by a customer, the disk may be shipped with the ordered product in the same package. If a purchase is made in the retailer's store, the disk may be enclosed in the shopping bag when the customer pays for the product. Mass mailings of the disk by the retailer may be made with a cardboard jacket on the disk, enclosure of the disk in a box, or by other packaging means suitable to protect the disk. The retailer may establish kiosks in shopping centers, stores, college campuses, or other public places where the disk may be directly given to potential customers.

Upon receipt of the mass storage media, the customer may insert the disk into his or her computer at step 304. Activation software stored on the disk may then execute browser software on the customer's computer as part of step 306. The browser may be a specific browser that allows a customer to view images and information on the disk as well as the retailer's web site. The specific browser may also be capable of browsing other sites on the Internet. The specific browser may be included on the disk. The activation software may also search the customer's computer for general web browsing software, which may be used to view images and information on the disk, the retailer's web site, and other web sites. The disk may also include general web browsing software which could be installed on the customer's computer to allow the customer to view images and information on the disk, the retailer's web site, and other web sites on the Internet.

The browser software may display the retailer's catalog in web page form in the browser, as part of step 308, including a banner that may contain the name and web address of the retailer. The banner may contain the name and the web address of a broadband Internet service provider. Alternatively, the information contained in the banner may rotate between the name and web address of the retailer and the name and web address of a broadband Internet service provider. Similarly, the banner may have a revolving display of information containing the names and web addresses of many retailers.

The invention may be used to market broadband Internet access. For example, a cable access or DSL marketer can send the disk by mass mailing, indicating that the customer can experience the benefits of broadband Internet connectivity by utilizing the disk. Furthermore, the customer may experience simulated high speed Internet access on all participating web sites if the broadband services being offered is purchased.

At step 310, the customer may select the retailer's name or web address in the banner. Selection of either the name or web address of the retailer will execute the customer's Internet Service Provider software, according to step 312, and establish a connection to the Internet. If the customer does not select the retailer's name or web address in the banner, images and product information may be displayed in web page form as step 308.

If the customer has selected the banner in step 310 and the customer's Internet Service Provider software has established a connection pursuant to step 312, the retailer's web page may be loaded into the customer's web browser at step 314.

In one aspect of the invention, if the retailer is a broadband Internet service provider, the broadband provider's web page may be displayed. The web page may give the user the option of signing up for the broadband provider's network connectivity services. A discount or special pricing on broadband Internet services may be presented to the customer in connection with the selection of the broadband provider's name or web address in the banner.

Selection of the web address in step 310 may send a reference code to the retailer's or broadband web provider's server. This reference code may allow the server to determine that the customer is utilizing the activation software and utility data on the distributed mass storage media. Operation of the retailer's web page on-line with knowledge of the reference code may differ from the normal operation of the retailer's web page on-line.

High resolution images and descriptions of products may be loaded from the mass storage media into the web browser rather than from the retailer's server. In this manner, product images may be loaded into the customer's web browser more quickly than if the image data had to be transferred from the retailer's server to the customer's computer. Thus, the behavior of the loading of the web page may simulate the speed at which the web page may load into the web browser if the customer subscribed to a broadband Internet service provider.

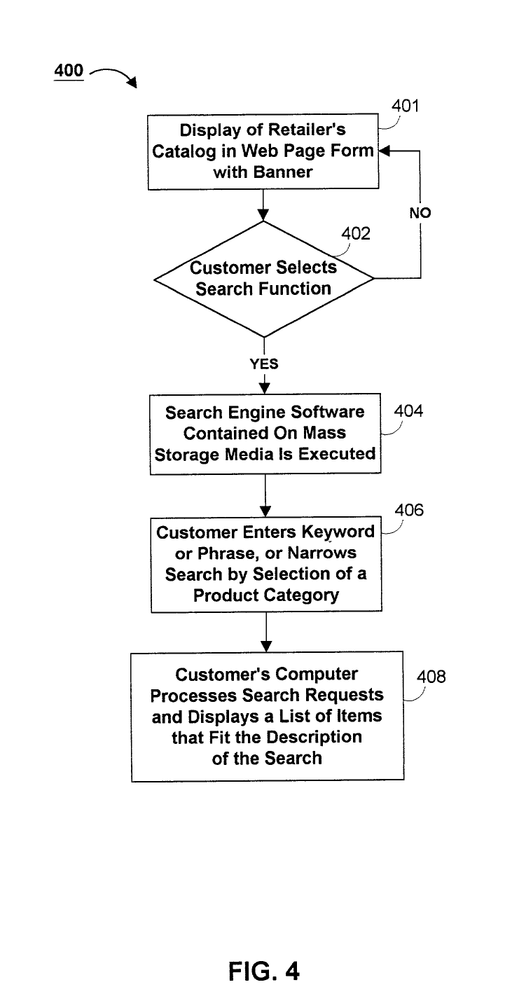

FIG. 4 illustrates a flow diagram of a process 400 for searching the retailer's catalog contained on the mass storage media in accordance with one aspect of the present invention. At step 401, the retailer's catalog is in web page form. Upon selection of the search function at step 402, search engine software contained on the mass storage device may be executed as step 404. If the customer does not select the search function at step 402, the retailer's catalog may be displayed in web page form with a banner at step 401.

If the search engine software is executed at step 404, the customer may enter a keyword or phrase at step 406. The customer may also elect to narrow the scope of the search at step 406 by selection of a specific product category to find the entered keyword or phrase.

At step 408, the customer's computer processes the search request, and displays a list of items that fit the description of the search.

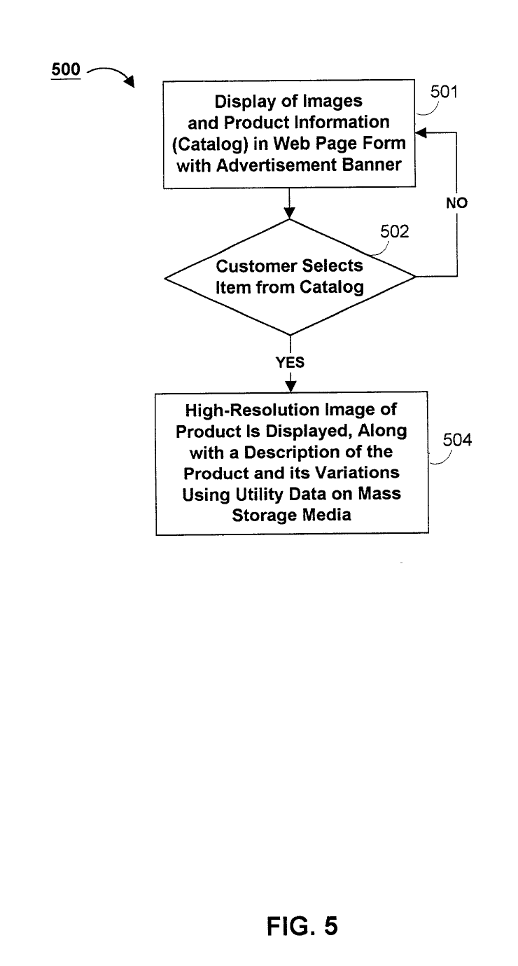

FIG. 5 illustrates a flow diagram of a process 500 for selecting an item from the retailer's catalog contained on the mass storage media accordance with one aspect of the present invention. At step 501, the retailer's catalog may be displayed in web page form.

At step 502, the customer can select an item from the catalog. If the customer selects an item, a high resolution image of the product may be displayed, along with a description of the product at step 504. Details such as available sizes, colors, or options may be included in the description. The data used to form the image and the description may be contained on the mass storage device. By having the image and description data load from the mass storage device to the web browser, rather than being transferred from the retailer's server across a communications network, the speed of a broadband Internet service connection may be simulated.

If the customer does not select an item from the catalog at step 502, images and product information may be displayed in web page form with an advertisement banner at step 501.

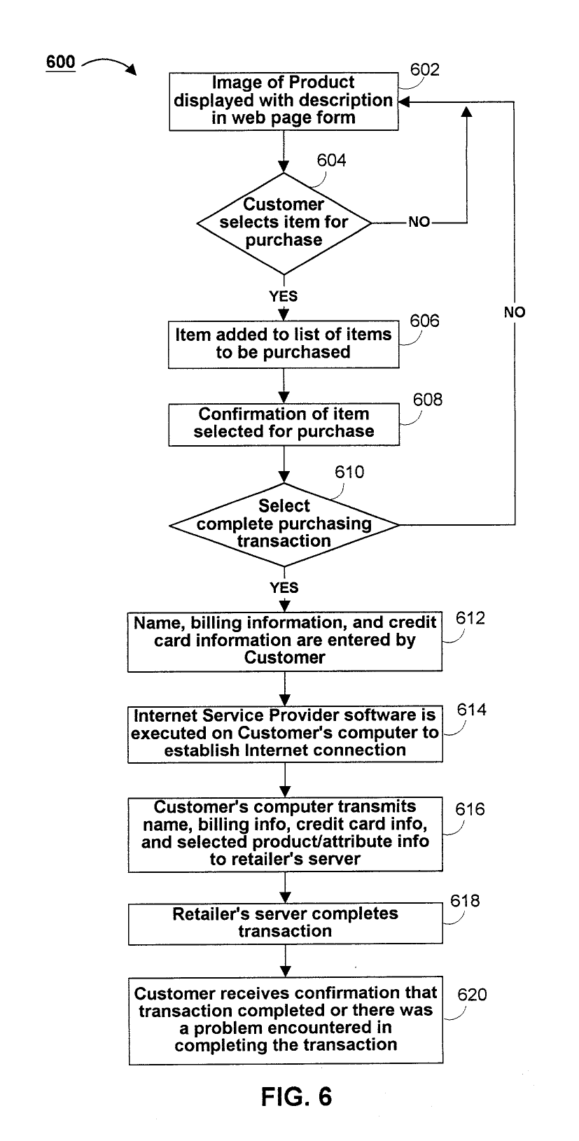

FIG. 6 illustrates a flow diagram of a process 600 for selecting an item for purchase from the retailer's catalog contained on the mass storage media according to one aspect of the invention. At step 602, an image and description of the product may be displayed in web page form.

At step 604, the customer may select an item for purchase. If the customer does not select an item for purchase, the image and description of a product may be displayed in web page form at step 602.

If a customer has selected an item for purchase at step 604, the selected item may be added to a list of items to be purchased at step 606. If the item is the first item that the user has selected for purchased, a list may be created.

Next, at step 608, confirmation of the item that was selected for purchase may be given to the customer. Step 608 may inform the customer that the item has been added to the list of items to be purchased, and may also display the attributes of the product that was selected. Information such as the name, model number, color, or size of the product may be displayed.

At step 610, the consumer may select to complete a purchasing transaction (check out) if the consumer is finished selecting items from the catalog. If the customer selects complete the transaction at step 610, the customer may next proceeds to step 612, where the customer is asked to input his or her name, billing information, and credit card information. If the customer does not select to complete the purchasing transaction, the image and product description for the selected product to be purchased may continue to be displayed at step 602.

Once the name, billing, and credit card information have been entered by the customer at step 612, the customer's Internet Service Provider software may be executed on the customer's computer in order to establish a connection with the Internet at step 614. Once an Internet connection has been established, the customer's computer may transmit the customer's name, billing information, credit card information, and list of items to be purchased to the retailer's server at step 616. The retailer's server may complete the transaction at step 618, and the customer may receive a confirmation that the transaction has been completed at step 620. Alternatively, if the transaction could not be completed, the customer may receive notification that the transaction could not be completed.

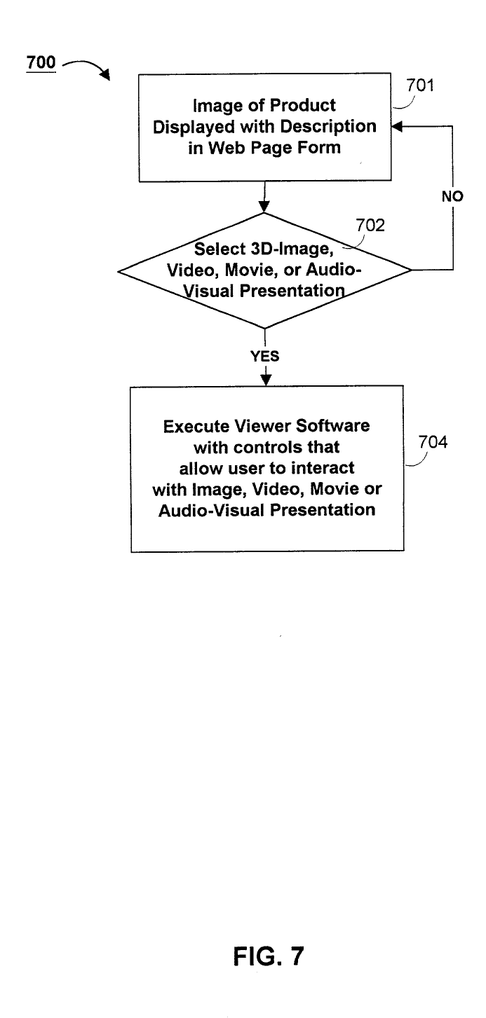

FIG. 7 illustrates a flow diagram of a process 700 for selecting a three dimensional image, a video, a movie, or an audio-visual presentation related to a particular item from the retailer's catalog contained on the mass storage media according to one aspect of the invention. Three-dimensional images, movies, video, or audio-visual presentations included on the disk may not be contained on the retailer's web site. Narrowband access to web sites may make utilization and manipulation of three-dimensional images, movies, videos, and audio-visual presentations impractical. The significant amount of data that must be transferred from the retailer's server to the customer's computer may make the rendering of the images, as well as the user interaction with the images, typically appear very slow.

At step 701, the image and description of a selected product may be displayed in web page form. At step 702, the customer may select to view a three dimensional image, a video, a movie, or an audio-visual presentation. If any of these options are selected, and data to produce the selected option is contained on the mass storage media, appropriate viewer software may be executed at step 704. If none of these options are selected, an image and a description of the product may be displayed in web page form at step 701.

The viewer software executed at step 704 may reside on either the customer's computer or on the mass storage media. The viewer software may allow the customer to interact with the three-dimensional image, video, movie, or audio-visual presentation. For example, the user may rotate the three-dimensional image in order to see various sides of a product by using the controls of the viewer software.

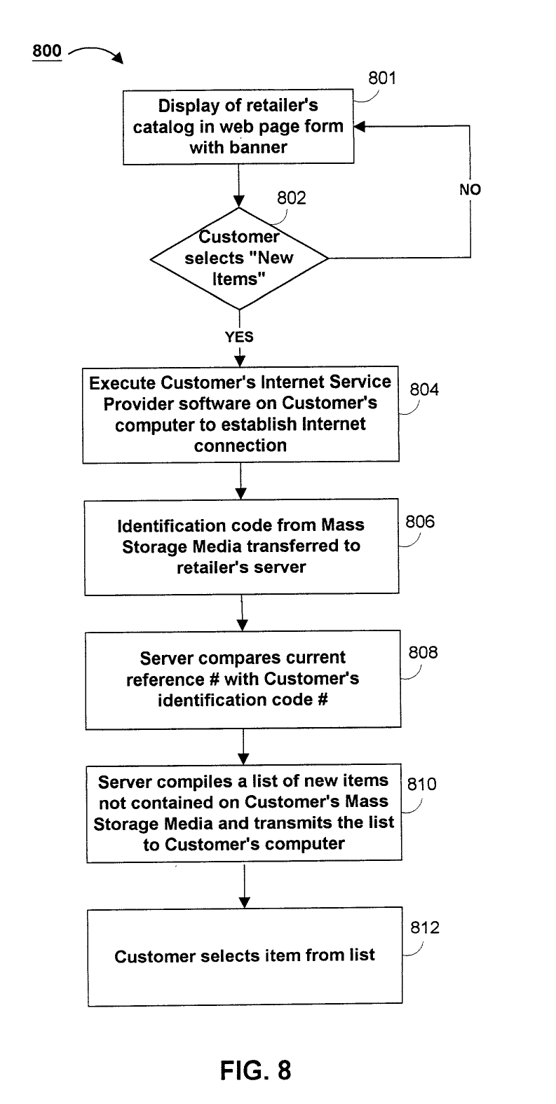

FIG. 8 illustrates a flow diagram of a process 800 for selecting a list of new items for purchase from the retailer's catalog not contained on the mass storage media according to one aspect of the invention. At step 801, the retailer's catalog may be displayed in web page form with a banner by using the data contained on the mass storage media. At step 802, the customer may select an option to view items sold by the retailer that are not contained on the mass storage media. If this selection is not made, the retailer's catalog may be displayed in web page form with a banner at step 801.

If the customer has selected to see new items at step 802, the customer's Internet service provider software may be executed in order to establish an Internet connection at step 804. Next, at step 806, a reference code contained on the mass storage device may be transmitted to the retailer's server. The retailer's server, at step 808, may compare a current reference code with the reference code transmitted by the customer.

At step 810, the server may compile a list of new items not contained on the customer's mass storage media and transmits the list to the customer's computer. If no new items exist in the retailer's catalog, the customer may be notified. If there are items in the catalog on the mass storage device that the retailer is no longer selling, the customer may be notified that the items are no longer available for sale. At step 812, the customer may select an item from the list.

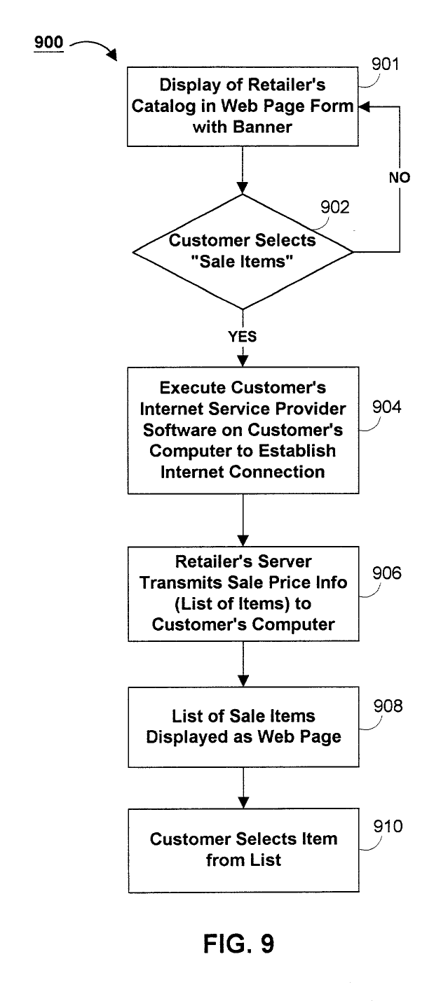

FIG. 9 illustrates a flow diagram of a process 900 for selecting a list of sale items according to one aspect of the invention. At step 901, the retailer's catalog may be displayed in web page form by using the data contained on the mass storage media. At step 902, the customer may select to obtain a list of on-sale items from the retailer. If the customer does not select sale items, the retailer's catalog may be displayed in web page form with a banner at step 901.

If the customer selects sale items at step 902, the customer's Internet Service Provider software may be executed in order to establish an Internet connection at step 904. The retailer's server, at step 906, may compile and transmit a list of items and their on-sale price to the customer's computer. The list of on-sale items may be displayed on the customer's computer in the form of a web page at step 908. At step 910, the customer may select an item from the list.

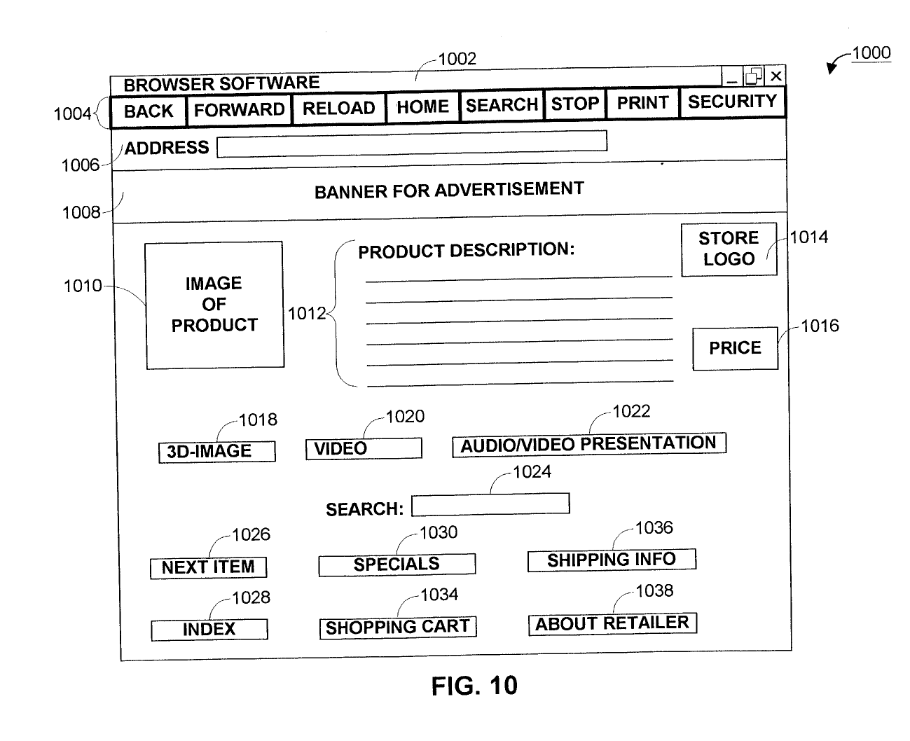

FIG. 10 is an illustration of screen display 1000 according to one aspect of the present invention. Browser software 1002 may be executed on the user's computing device. Browser software 1002 may be stored on the mass storage media, or in any storage device located in or connected to the user's computing device.

Browser software 1002 may include browser controls 1004 for controlling the display of simulated web pages. Browser controls 1004 may include controls for loading the previously displayed web page, loading the next simulated web page, reloading the current simulated web page, returning to a default simulated web page, searching simulated web pages, stopping the transfer of simulated web pages, printing a simulated web page, and inquiring about the security of transactions on simulated web pages.

Browser software 1002 may also contain address dialog box 1006 that may be used for inputting or displaying the address of a web site. An address of an information provider may be entered in the address dialog box 1006 to load a web page into browser software 1002.

Screen display 1000 may also contains banner for advertisement 1008. While FIG. 10 shows the banner for advertisement 1008 at the top of the simulated web page, the banner may be located anywhere within the simulated web page. Banner for advertisement 1008 may be a banner for many different advertisers. Advertiser information may be rotated within the banner periodically. In this manner, many advertisers may utilize the same area for banner for advertisement 1006.

Image of product 1010 may be a high resolution image of a product offered by a retailer. If the web site displayed is that of an information provider, the image of product 1010 may be any image that the information provider may convey to the user. Data to form image of product 1010 may be provided by the distributed mass storage device, a server, or a storage device on the user's computing device.

Product description 1012 is a text description of the attributes of the image of product 1010. Product description 1012 may contain such information as model number, sizes available, colors available, dimensions, weight, shipping costs, availability, and options. If an information provider's web site is displayed, product description 1012 may convey textual information to the user.

Store logo 1014 may be a high resolution image of the logo or trademark of a retailer. If the web site displayed may be that of an information provider, store logo 1014 may be the logo or trademark of the information provider.

Price 1016 may contain the price of the product displayed in image of product 1010 and product description 1012. The data for price 1016 may come from the distributed mass storage media, the server, or a storage device on the user's computing device.

3D-image button 1018 may be displayed if data is available for the display of a three dimensional image involving the product or information. The data to create the three dimensional image may be transferred from the mass storage device, the server, or a storage device on the user's computing device. By selecting 3D-image button 1018, a separate viewer widow may be executed, where the viewer may have controls to manipulate the image in real time. For example, a user may use the controls of the viewer in order to see a product from different sides or angles. The viewer software may be stored on the mass storage device, the server, or the user's computing device.

Video button 1020 may be displayed if data is available for the display of a video related to the product or information displayed in browser 1002. The data to create the video may be transferred from the mass storage device, the server, or a storage device on the user's computing device. By selecting the video button 1020, a separate viewer widow may be executed, where the viewer may have controls to manipulate the video in real time. For example, the user may be able to rewind, fast-forward, stop, pause, or play the video. The viewer software may be stored on the mass storage device, the server, or the user's computing device.

Audio/Video presentation button 1022 may be displayed if data is available for the display of a video related to the product or information displayed in browser 1002. The data to create the audio-visual presentation may be transferred from the mass storage device, the server, or a storage device on the user's computing device. By selecting the audio/video button 1022, a separate viewer widow may be executed, where the viewer may have controls to manipulate the presentation in real time. For example, the user may be able to rewind, fast-forward, stop, pause, or play the presentation. The viewer software may be stored on the mass storage device, the server, or the user's computing device.

Search dialog box 1024 may be used to find products or information in the simulated web site. For example, the user may enter the name of a product they are looking for in order to determine if the retailer is selling it. The user may enter such things as the product name, model number, description, or a product category into search dialog box 1024. Search engine software may be used to create a list of search results, given the user's entered words, phrases, or numbers. The search engine software may be located on the mass storage media, the server, or on the storage device of the user's computing device. Given the user's entry of information into search dialog box 1024, the search engine software may search the mass storage media, the server, or the storage device of the user's computing device.

Next item button 1026, when selected, may display the next product item in a retailer's catalog in browser software 1002. A new image of product 1010, product description 1012, and price 1016 may be updated in the simulated web page displayed in browser software 1002. Data to produce the simulated web page for the next item may be available on the mass storage media, the server, or the storage device of the user's computing device.

Index button 1028, when selected, may display an index of the retailer's product catalog in a simulated web page form in browser 1002. Data to produce the simulated web page for the index may be available on the mass storage media, the server, or the storage device of the user's computing device.

Specials button 1030, when selected, may display a list of the retailer's on-sale items in simulated web page form in browser 1002. Data to produce the simulated web page for the list of on-sale items may be available on the mass storage media, the server, or the storage device of the user's computing device.

Shopping cart button 1034, when selected, may allow the user to add the product displayed to a list of items to purchase. Shopping cart button 1034 may also be used to view a list of items that have already been selected for purchase by the user. Once the user has finished selecting items for purchase, the user may elect to complete a purchasing transaction. In order to complete a purchasing transaction, a user may be required to enter their name, address, and credit card information.

Shipping info button 1036, when selected, may provide a listing of shipping service providers that the retailer may utilize. Options regarding the speed of the delivery service, and the prices for such services, may be given to the user. General listings of prices to ship items may also be given to the user.

About retailer button 1038, when selected, may provide background information about the retailer, the retailer's business, the retailer's address and contact information. User's may utilize this information in order to learn more about the retailer, the retailer's business, or how to contact the retailer.

Thus, it is seen that systems and methods for stimulating web pages are provided according to the principles of the present invention. Persons skilled in the art will appreciate that the present invention can be practiced by other than the described embodiments, which are presented for purposes of illustration rather than of limitation, and the present invention is limited only by the claims which follow.

What is claimed is:

1. A method for displaying information, comprising:
distributing a mass storage medium to a user;
connecting a mass storage medium to a computing device;
retrieving data from a remote server;
retrieving data from the mass storage medium; and
displaying a simulated web page using the data from the mass storage medium and the data from the remote server.

2. The method of claim 1, further comprising:
determining whether the data is to be retrieved from the remote server.

3. The method of claim 1, further comprising:
determining whether the data is to be retrieved from the mass storage medium.

4. The method of claim 1, further comprising:
determining whether additional data is required to display the simulated web page.

5. The method of claim 1, further comprising:
receiving a selection of an advertisement.

6. The method of claim 1, further comprising:
receiving a request for product information.

7. The method of claim 1, further comprising:
receiving a selection of an item to be purchased;
receiving billing information; and
processing a purchase transaction for the item using the billing information.

8. The method of claim 1, further comprising:
performing a search for items;
listing results of the search; and
receiving a selection of an item in the results.

9. The method of claim 1, wherein the data from the remote server includes a list of new items.

10. The method of claim 1, wherein the data from the remote server includes a list of on-sale items.

11. The method of claim 1, wherein the data from the mass storage medium includes images.

12. The method of claim 1, wherein the data from the mass storage medium includes video.

13. The method of claim 1, wherein the data from the mass storage medium includes audio.

14. The method of claim 1, wherein the data from the mass storage medium includes text descriptions.

15. The method of claim 1, wherein the data from the mass storage medium includes application software.

16. A system for displaying information, comprising:
a mass storage medium comprising data;
a remote server comprising data;
a computer that receives the data from the mass storage medium and the data from the remote server, and that displays a simulated web page using the data from the mass storage medium and the data from the remote server.

17. The system of claim 16, wherein the computer is coupled to the remote server via a computer network.

18. The server of claim 17, wherein the computer network is the Internet.

19. The system of claim 16, wherein the computer determines whether to receive the data from the mass storage medium.

20. The system of claim 16, wherein the computer determines whether to receive the data from the remote server.

21. The system of claim 16, wherein the computer determines whether additional data is required to display the simulated web page.

22. The system of claim 16, wherein the computer receives a selection of an advertisement.

23. The system of claim 16, wherein the computer receives a request for product information.

24. The system of claim 16, wherein the computer:
receives a selection of an item to be purchased;
receives billing information; and
processes a purchase transaction for the item using the billing information.

25. The system of claim 16, wherein the computer:
performs a search for items;
lists results of the search; and
receives a selection of an item in the results.

26. The system of claim 16, wherein the remote server performs a search for items, and the computer lists results of the search and receives a selection of an item in the results.

27. The system of claim 16, wherein the data from the remote server includes a list of new items.

28. The system of claim 16, wherein the data from the remote server includes a list of on-sale items.

29. The system of claim 16, wherein the data from the mass storage medium includes images.

30. The system of claim 16, wherein the data from the mass storage medium includes video.

31. The system of claim 16, wherein the data from the mass storage medium includes audio.

32. The system of claim 16, wherein the data from the mass storage medium includes text descriptions.

33. The system of claim 16, wherein the data from the mass storage medium includes application software.
